(19) United States
(12) Patent Application Publication
(10) Pub. No.: US 2008/0184242 A1
(43) Pub. Date: Jul. 31, 2008

(54) INFORMATION APPARATUS, INFORMATION PROCESSING METHOD AND COMPUTER-READABLE STORAGE MEDIUM

(75) Inventor: Osamu YOSHIMURA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/951,599

(22) Filed: Dec. 6, 2007

(30) Foreign Application Priority Data
Jan. 25, 2007 (JP) 2007-15037

(51) Int. Cl. G06F 9/455

(52) U.S. Cl. 718/102

(57) ABSTRACT

An information and method acquiring an environment information relevant to an execution of a predetermined process determining a processing condition based on the environment information and executing the process in accordance with the processing condition at predetermined timing.

### CROSS-REFERENCE TO RELATED APPLICATIONS

This application is related to and claims the benefit of priority from Japanese Patent Application No. 2007-15037, filed on Jan. 25, 2007, the entire contents of which are incorporated herein by reference.

### BACKGROUND OF THE INVENTION

1. Field of Invention

The present invention relates to information processing, and more particularly, to a technology that executes a program of an information apparatus (computer) automatically.

2. Description of the Related Art

Generally, shops or other providers display computers in the shops so that those interested who come to the shops can explore functions and operational feeling of the computers.

These displayed computers automatically execute the programs for demonstration and present the functions and performance of the computers to potential customers when the customers are not operating the computers.

Although a solution such as, for example, discussed in Japanese Laid-open Patent Application No. 2005-309841 has been provided, there is a need for optimally displaying and presenting information.

### SUMMARY

An information apparatus and method are disclosed for acquiring an environment information relevant to an execution of a predetermined process, determining a processing condition based on the environment information and executing the process in accordance with the processing condition at predetermined timing.

Additional aspects and/or advantages will be set forth in part in the description which follows and, in part will be apparent from the description, or may be learned by practice of the invention.

The disclosed information apparatus and method includes acquiring a screen resolution of a display as the environment information, selecting image data corresponding to the screen resolution of the display, setting a processing condition causing the process to use the selected image data, and controlling display of an image on the display based on the selected image as the process.

### BRIEF DESCRIPTION OF THE DRAWINGS

These and/or other aspects and advantages will become apparent and more readily appreciated from the following description of the embodiments, taken in conjunction with the accompanying drawings of which.

FIG. 1 is a schematic diagram illustrating an information apparatus.

FIG. 2 is a flowchart illustrating an information processing method.

FIG. 3 is a diagram illustrating corresponding data stored for the information processing.

FIG. 4 is a diagram illustrating an area of display in accordance with the information processing.

### DETAILED DESCRIPTION OF THE PREFERRED EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

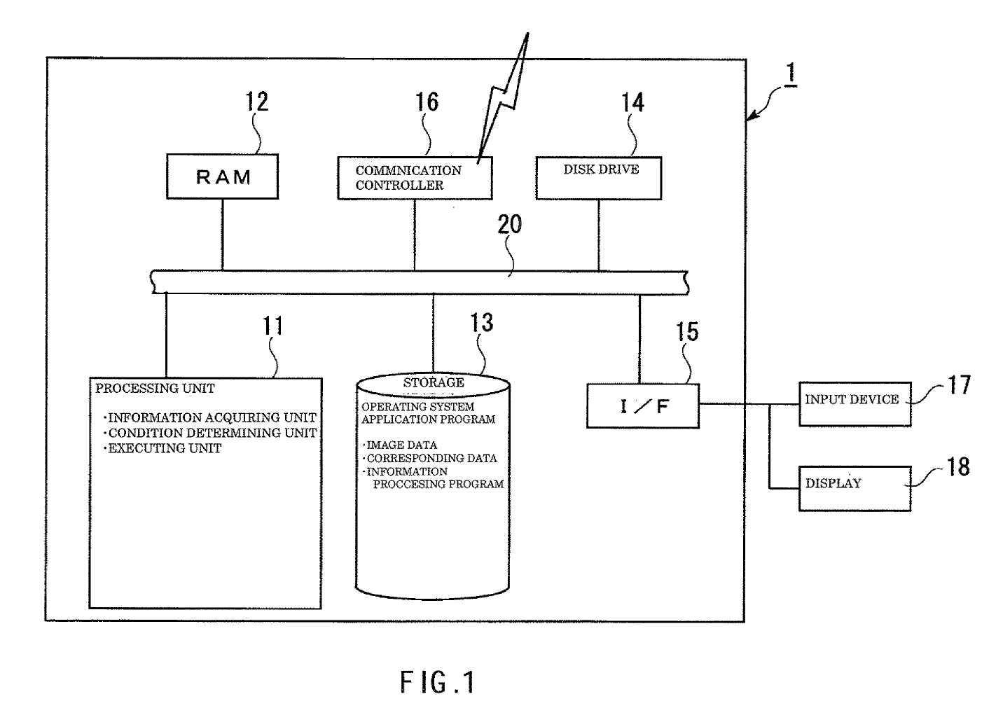

FIG. 1 is a block diagram illustrating an exemplary configuration of an information apparatus 1. The information apparatus (computer) 1 includes a processing unit 11, a main memory (RAM: Random Access Memory) 12, a storage unit (hard disk) 13, a disk drive 14, an interface 15 enabling peripheral equipment connection, and a communication controller 16. As illustrated in FIG. 1, each component of the information apparatus 1 is mutually connected by a bus 20.

The storage unit 13 stores data and software (such as, an OS: Operating System, information processing program, or other application program(s), etc.) to perform arithmetic processing. The data stored in the storage unit 13 may include various types of data including but not limited to image data, condition(s) for information processing, identifier(s) of device(s), etc.

The disk drive 14 reads from and writes in a storage media such as a flexible disk, CD (Compact Disc), DVD (Digital Versatile Disk), and MO (Magneto Optical disk).

The interface 15 is used to connect an input device 17, such as a keyboard, a pointing device, a display 18, etc. to the information apparatus (computer) 1.

The communication controller 16 controls communication between the information apparatus (computer) 1 and other computers or devices.

The processing unit 11 reads the above-mentioned OS and/or application program from the storage unit 13 and executes operations thereof arbitrarily or automatically at predetermined intervals. As a result of the execution, the processing unit 11 operates as an information acquiring unit, a condition determining unit and an executing unit by performing arithmetic processing using information input from the interface 15 and the communication controller 16, and information read out from the storage unit 13. Although FIG. 1 is described using particular configurations and components, the present invention is not limited to any particular configuration. For example, separate or independent components may be provided to the information processing apparatus (computer) 1 to execute operations related to acquiring environment information, determining a predetermined condition and executing operations based on the condition.

The information acquiring unit acquires environment information such as information about the display 18 connected with the information apparatus (computer) 1 and a state of resource(s) of the computer 1 using an API (Application Program Interface), for example.

The condition determining unit determines a processing condition by checking the acquired environment information against such as a predetermined condition, a reference value and corresponding data further described below in detail.

The executing unit automatically executes a program according to the processing condition determined by the condition determining unit at predetermined timing.

Further, while the invention is described with demonstration of a computer, the present invention is not limited to any particular device, and may be implemented on a handheld computer, a desktop or laptop system, or any other similar device enabled to execute operations of a program.

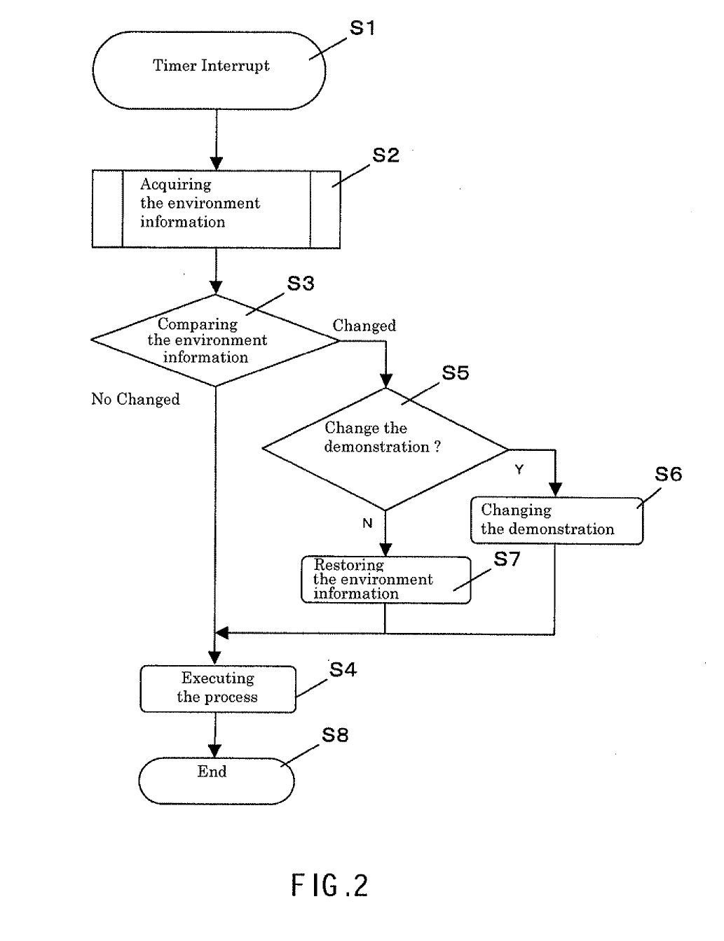

FIG. 2 illustrates an information processing method using which the information apparatus (computer) 1 performs operations.

A program, for example one used for demonstration purposes is read out from a computer-readable storage medium, such as a CD-ROM, etc., by the disk drive 14 and is installed on the storage unit 13. Alternatively, as an installation mode, the program may be installed by downloading the same from another computer or device via a network by the communication controller 16. Here, as a storage medium, any storage medium technology capable of accumulating or registering information such as data or program by electric, magnetic, optical, mechanical or chemical action that can be read from a computer may be used. Among such storage media, the storage medium that can be removed from the computer is not only a CD-ROM, but for example, a flexible disk, a magnetic-optical disk, CD-R/W, DVD, DAT, an 8 mm tape, and a memory card. In addition, the storage media fixed to the computer are such as a hard disk and ROM (read-only memory).

A demonstration program may be a so-called screensaver which displays image data (static image, video, etc.) on the display 18 if there is no input from the input device 17 during a period of time set beforehand, and ends this display when there is an input from the input device 17 during the display.

The processing unit 11 monitors whether a state without an input from the input device 17 (an idle period) lasts more than a predetermined period of time or not, that is, whether the predetermined timing has occurred or not. When determining that the predetermined timing has occurred, the processing unit 11 generates an interrupt and starts the demonstration program (operation S1). And, the information acquiring unit acquires current environment information (operation S2).

The condition determining unit compares the currently acquired environment information with environment information acquired when the demonstration program started at the previous time, and determines whether the environment of the computer 1 has changed or not, that is, whether it is necessary to change the processing condition (operation S3).

When determining that the environment has not changed in operation S3, the executing unit displays image data without requiring changing of the processing condition (operation 54).

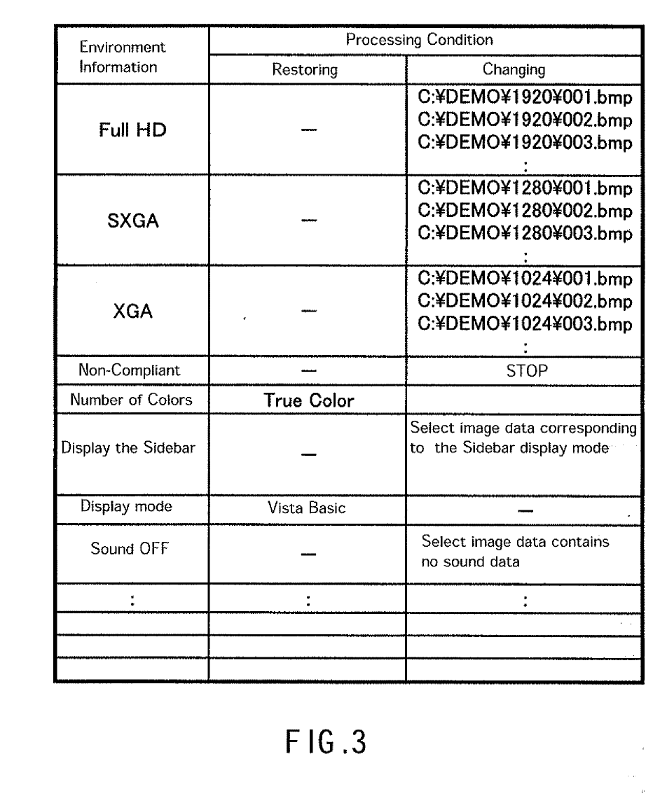

On the other hand, when determining that the environment has changed in operation S3, the condition determining unit refers to corresponding data (as shown in FIG. 3) stored in the storage unit 13, and determines whether the processing condition is restoring the environment setting to the previous setting or changing the demonstration (operation S5). If the processing condition corresponding to the current environment information is to change the demonstration, the executing unit changes the demonstration in accordance with the processing condition (operation S6), and then displays the image data (operation S4).

In addition, if the processing condition corresponding to the current environment information is restoring the environment information to the previous one in the operation S5, the executing unit restores the environment information to the predetermined value in accordance with the processing condition (operation S7) and displays the image data and executes the process (operation S4).

Next, processing according to the environment information is explained in detail.

### (1) Screen Resolution

When the information acquiring unit acquires a screen resolution of the display 18, for example, as the environment information, the condition determining unit refers to corresponding data and determines, using image data corresponding to the acquired screen resolution, to execute the demonstration program as a processing condition.

Here, the information acquiring unit receives identification information (such as display ID) from the display connected via the interface 15 such as HDMI (High-Definition Multimedia Interface) or DVI (Digital Visual Interface), and acquires information about the screen resolution corresponding to the identification information from the storage unit 13. In addition, with respect to the display that may be connected with the computer 1, the storage unit 13 stores identification information and information about the screen resolution of the display in association with each other.

In addition, in one embodiment, image data of the same contents but three different screen resolutions (1920×1080 pixels, 1280×1024 pixels, 1024×768 pixels) are prepared and stored in each folder (C: ¥DEMO¥1920, C: ¥DEMO¥1280, C: ¥DEMO¥1024) of the storage unit 13 when the demonstration program is installed.

As shown in FIG. 3, path names of each screen resolution and each image data are registered with corresponding data.

Consequently, if the screen resolution of the display is Full HD, image data with 1920×1080 pixels is selected. If the screen resolution is SXGA, image data with 1280×1024 pixels is selected. If the screen resolution is XGA, image data with 1024×768 pixels is selected. The executing unit displays the selected image data on the display 18.

As a result, the executing unit is enabled to display the image of a maximum screen resolution of the display 18 without requiring compression and reduction, thereby displaying the image beautifully with good tempo.

In addition, if the screen resolution of the display acquired by the information acquiring unit is other than the above three kinds of screen resolutions, the condition determining unit cannot select optimum image data, that is, it determines that the condition for executing is not satisfied (operation S5; No), the executing unit stops processing the demonstration program (displaying image) (operation S6).

### (2) The Number of Display Colors

The information acquiring unit acquires the number of display colors currently set in the computer as environment information, and the condition determining unit determines whether the number of display colors are changed from the predetermined value (True Color) or not (operation S3). When determining that the setting of the number of colors is changed, the executing unit restores the setting about the number of colors to the predetermined value (True Color) and displays the image.

Image data may be created with True Color to display the image optimally and as beautifully as possible. When those who come to a shop or at a location of a provider to tryout and explore computers, they might change the number of colors set in the computer. As a result, in the one embodiment, it is determined whether the setting pertaining to the number of colors of the computer is changed or not when the demonstration program starts, and if the setting is changed, it is determined as the condition for executing is not satisfied and the setting about the number of colors is restored to the predetermined value and then execution is performed (displaying image) under proper environment.

### (3) Display Area for Displaying Data

When the information acquiring unit acquires information of display area for displaying data of an operating system as environment information, the condition determining unit selects image data corresponding to the display area part excluding the display area acquired by referring to the corresponding data and determines to use the selected image data to execute the demonstration program as the processing conditions.

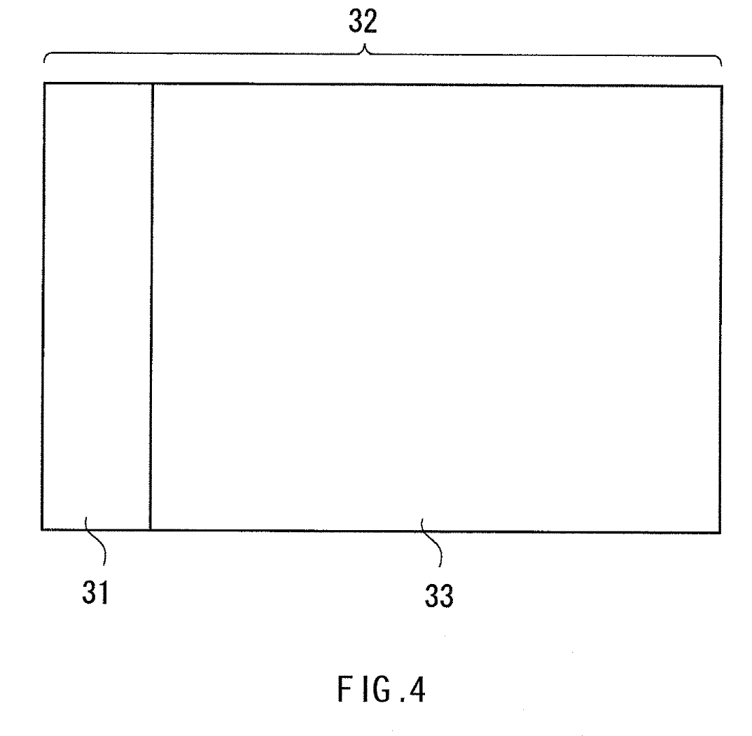

For example, in Windows Vista (registered trademark), as shown in FIG. 4, when the setting to display the sidebar 31 on the foreground is made, the display area of the image data becomes a part 33 excluding sidebar 31 from the display area 32 of the display 18 (FIG. 1).

As a result, the condition determining unit selects the image data with pixels of the part 33 that remains after excluding the sidebar 31 from the display area 32 of the display 18.

That is, if a width of the sidebar 31 is 150 pixels to a display having a screen resolution as Full HD, image data with 1770×1080 pixels is prepared. The condition determining unit selects image data corresponding to the display when such a display is connected with the computer 1.

### (4) Display Mode

When a display mode of Windows Vista is Vista Aero or Vista Standard, for example, the computer 1 uses a lot of resources. As a result, when image data is displayed in such a display mode, the computer 1 may lack adequate resources.

As a result, the information acquiring unit acquires the display mode as the environment information, and the condition determining unit determines to restore to the predetermined value (for example Vista Basic, etc) as the processing condition (operation S5; No) when the acquired display mode is Vista Aero or Vista Standard. The executing unit executes the process and displays the image (operation S4) after restoring the display mode to the predetermined value according to the processing condition (operation S7). In addition, the executing unit reconfigures to the original display mode (Vista Aero or Vista Standard) when the processing (displaying the image) of the demonstration program ends (operation S8).

### (5) Brightness of the Display

The information acquiring unit acquires a set value concerning the brightness of the display 18 (for example, a liquid crystal display, etc.) as the environment information, and if this set value was changed from the predetermined value (operation S3), the executing unit displays the image after restoring this set value to the predetermined value (for example, maximum value).

Many computer shops use strong lighting inside the shops. Under such circumstances, to display the image of the demonstration program brilliantly, one embodiment sets the predetermined value of the brightness of the display 18 as the maximal brightness.

As a result, if customers change the brightness setting of the display from the predetermined value to other value when customers tryout or explore the computer 1, the condition determining unit determines that the condition for executing is not satisfied when the demonstration program starts. When the condition determining unit determines that the condition is not satisfied, the executing unit restores the set value of the brightness of the display to the predetermined value to execute demonstration (display the image) under an appropriate environment.

### (6) Sound

When a plurality of computers 1 are displayed in a shop, if sound is output from all the computers 1, the customers may not be able to hear contents of the sound. Therefore, most of the computers on display are set not to output sound.

At this time, since it is inappropriate that image data including content such as a music video and audio commentary concerning function of the computer is displayed, the information acquiring unit acquires the setting information of the sound output as the environment information. When the setting information is indicative of inhibiting sound output (mute setting or invalid setting of sound output), the condition determining unit selects image data that doesn't include sound data. To make this selection possible, each image data is created to be determined whether the sound data exists or not from attribute information of the image data such as the property, file name, etc.

In addition, when the setting information of sound output acquired by the information acquiring unit makes sound output enabled, the condition determining unit may select the image data including sound data. As a result, appropriate image data can be displayed according to the setting concerning whether there is sound output via the computer or not.

### (7) Resources

The information acquiring unit acquires information of resources of the computer 1, such as the CPU utilization, memory occupancy, etc., using API (Application Programming Interface) as environment information. If the condition determining unit determines that a remainder of the resource is less than the predetermined value based on the acquired information, that is, the resource is insufficient (the condition for executing is not satisfied), the executing unit discontinues the execution of the demonstration program.

If the demonstration program is executed in the state where the resource is insufficient, for example, due to other applications being executed, contents displayed by the demonstration program may deteriorate, such as the video included in the demonstration may be displayed in inept ways and the display of the image is switched slowly, then it may give those who come to the shop a bad impression.

Therefore, the disclosed information apparatus and method discontinues automatic execution of the demonstration program when the resource is insufficient and it is an inappropriate environment to display the demonstration to avoid giving an unfavorable impression to those who come to the shop, or a location of a provider.

Though the above-mentioned embodiment shows the example of displaying the image data by executing the program, the present invention is not limited to this embodiment, any processing that the information apparatus can execute may be implemented using the present invention.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. An information apparatus, comprising:
an information acquiring unit acquiring an environment information relevant to an execution of a predetermined process;
a condition determining unit determining a processing condition based on the environment information acquired; and
an executing unit executing the process in accordance with the processing condition at predetermined timing.

2. The information apparatus according to claim 1, wherein:
the information acquiring unit acquires a screen resolution of a display as the environment information,
the condition determining unit selects image data corresponding to the screen resolution of the display from a plurality of image data and sets the processing condition causing the process to use the selected image data, and
the executing unit controls display of an image on the display based on the selected image data as the process.

3. The information apparatus according to claim 1, wherein:
the information acquiring unit acquires a data display area of an operating system on a screen as the environment information,
the condition determining unit selects image data corresponding to the data display area from a plurality of image data and sets the processing condition causing the process to use the selected image data, and
the executing unit controls display of an image on the display based on the selected image data as the process.

4. The information apparatus according to claim 1, wherein,
the condition determining unit determines whether the environment information acquired satisfies a condition for executing the process, and
the executing unit starts executing the process with the environment information set to a predetermined value when determining that the environment information does not satisfy the condition for executing the process.

5. The information apparatus according to claim 1, wherein:
the condition determining unit determines whether the environment information satisfies a condition for executing the process, and
the executing unit stops executing the process when determining that the environment information does not satisfy the condition for executing the process.

6. The information apparatus according to claim 1, wherein:
the information acquiring unit acquires a setting information relevant to a sound output as the environment information,
the condition determining unit selects image data containing no sound data from a plurality of image data when determining that the setting information inhibits output of the sound and sets the processing condition causing the process to use the selected image data, and
the executing unit controls display of an image on the display based on the selected image data as the process.

7. An information processing method, the method comprising:
acquiring an environment information relevant to an execution of a predetermined process;
determining a processing condition based on the environment information; and
executing the process in accordance with the processing condition at predetermined timing.

8. The information processing method according to claim 7, wherein:
the acquiring includes obtaining a screen resolution of a display as the environment information,
the determining includes:
selecting image data corresponding to the screen resolution of the display from a plurality of image data, and
setting the processing condition causing the process to use the selected image data, and
where the executing controls display of an image on the display based on the selected image data as the process.

9. The information processing method according to claim 7, wherein
the acquiring includes obtaining a data display area of an operating system on a screen of a display as the environment information,
the determining includes:
selecting image data corresponding to the data display area from a plurality of image data, and
setting the processing condition causing the process to use the selected image data, and
the executing controls display of an image based on the selected image data as the process.

10. The information processing method according to claim 7, wherein:
the determining includes determining whether the environment information acquired satisfies a condition for executing the process, and
the executing starts the process with the environment set to a predetermined value when determining that the environment information does not satisfy the condition for executing the process.

11. The information processing method according to claim 7, wherein:
the determining includes determining whether the environment information acquired satisfies a condition for executing the process, and
the executing stops starting the process when determining that the environment information does not satisfy the condition for executing for the process.

12. The information processing method according to claim 7, wherein:
the acquiring includes obtaining a setting information relevant to a sound output as the environment information,
the determining includes:
selecting image data containing no sound data from a plurality of image data when determining that the setting information inhibits output of the sound, and
setting the processing condition causing the process to use the selected image data, and
the executing controls display of an image on the display based on the selected image data as the process.

13. A computer-readable storage medium including a program to cause an information apparatus to execute operations, the program comprising:
acquiring an environment information relevant to an execution of a predetermined process;
determining a processing condition based on the environment information acquired; and
executing the process in accordance with the processing condition at predetermined timing.

14. The computer-readable storage medium according to claim 13, wherein:
the acquiring includes obtaining a screen resolution of a display as the environment information,
the determining includes:
selecting image data corresponding to the screen resolution of the display from a plurality of image data, and
setting the processing condition causing the process to use the selected image data, and
the executing controls to display an image on the display based on the selected image data as the process.

15. The computer-readable storage medium according to claim 13, wherein:
the acquiring includes obtaining a data display area of an operating system on the screen of a display,
the determining includes:
selecting image data corresponding to the data display area from a plurality of image data, and
setting the processing condition causing the process to use the selected image data, and
the executing controls display of an image on the display based on the selected image data as the process.

16. The computer-readable storage medium according to claim 13, wherein:
the determining includes determining whether the environment information acquired satisfies a condition for executing the process, and
the executing starts the process with the environment sets to a predetermined value when determining that the environment information does not satisfy the condition for executing the process.

17. The computer-readable storage medium according to claim 13, wherein:
the determining includes determining whether the environment information acquired satisfies a condition for executing the process, and
the executing stops starting the process when determining that the environment information does not satisfy the condition.

18. The computer-readable storage medium according to claim 13, wherein:
the acquiring includes obtaining a setting information relevant to a sound output as the environment information,
the determining includes:
selecting image data contains no sound data from a plurality of image data when determining that the setting information inhibits output of the sound, and
setting the processing condition causing the process to use the selected image data, and
the executing controls display of an image on the display based on the selected image data as the process.

19. The computer-readable storage medium according to claim 13, wherein the program is a screen-saver.

20. An information processing method, comprising:
determining a condition of an operation during an idle period using a current environment setting indicated for the operation; and
automatically setting the condition in response to an indication by said determining that the condition is not set for the operation.
